(19) United States
(12) Patent Application Publication
(10) Pub. No.: US 2013/0147738 A1
(43) Pub. Date: Jun. 13, 2013

(54) PORTABLE TERMINAL

(71) Applicant: Samsung Electronics Co., Ltd., Gyeonggi-do (KR)

(72) Inventors: Eun-Hwa LEE, Gyeonggi-do (KR); Yu-Dong BAE, Gyeonggi-do (KR); Ji-Hyun JUNG, Gyeonggi-do (KR); Young-Min LEE, Gyeonggi-do (KR); Jeong-Seok LEE, Gyeonggi-do (KR)

(73) Assignee: Samsung Electronics Co., Ltd., Gyeonggi-do (KR)

(21) Appl. No.: 13/707,025

(22) Filed: Dec. 6, 2012

(30) Foreign Application Priority Data
Dec. 7, 2011 (KR) 10-2011-0130414

(51) Int. Cl. G06F 3/041

(52) U.S. Cl. CPC G06F 3/041
USPC 345/173

(57) ABSTRACT

A portable terminal includes a haptic device; and a plurality of actuators arranged in the haptic device, each of the actuators locally generating vibration in response to a touch on the haptic device.

### PRIORITY

This application claims the priority under 35 U.S.C. §119(a) to Korean Application Serial No. 10-2011-0130414, which was filed in the Korean Intellectual Property Office on Dec. 7, 2011, the entire content of which is hereby incorporated by reference.

### BACKGROUND OF THE INVENTION

1. Field of the Invention

The present invention relates generally to a portable terminal, and more particularly, to a portable terminal for providing multiple haptic feedback functions.

2. Description of the Related Art

The term “haptic feedback” includes a force feedback function, etc. for remotely controlling a robot arm, and refers to a means to express information based on the user's tactile sensation and skin contact. Lately, research is being actively conducted to use haptic feedback for a function for informing a user that a signal value of a key selected by the user has been normally input in a touch screen operation by the user, as well as a simple vibration function for alerting the user of call termination, in a portable terminal such as a cellular phone.

Generally, when the portable terminal receives a message or a call, the portable terminal provides the user with a vibration mode, as a method for alerting the user to receive the message or the call through the portable terminal. For operation of the portable terminal in the vibration mode, the portable terminal is provided with a vibration motor therein.

In consideration of portability and miniaturization of the portable terminal, the vibration motor is typically a coin type motor, or a cylinder or bar type motor, which simply provides only a call notification function.

Meanwhile, with the recent appearance of a touchscreen phone which can provide a full-browsing screen for use of the Internet, an input device such as a keypad has been realized by a virtual touchscreen keypad, wherein the touchscreen keypad may be configured to sense a position contacted by the user to receive an input of a signal value allocated in the corresponding position. A general button type keypad typically uses a dome switch, to provide the user with a click feeling, thereby allowing the user to sense an operation of the keypad through a tactile sensation. As a result, a user, who has been accustomed to a keypad array of a portable terminal, can be aware that a desired number or character is being selected and entered through the operation of the keypad, even without visually identifying the display device of the portable terminal for confirmation. On the contrary, because a keypad embodied in a touchscreen does not provide the same click feeling as that of the dome switch, a user operating the keypad embodied in a touchscreen should directly and visually identify the value input through a display device.

Accordingly, there have been continuous efforts to overcome a user's inconvenience in confirming an entered value one by one through the display device, by adding a haptic feedback function to the portable terminal including a touchscreen type input device. The haptic feedback function of the portable terminal as described above is embodied by operating a vibration motor when the touchscreen is operated.

Haptic feedback devices are disclosed in Korean Patent Publication No. 10-2011-0075714 and Korean Patent Registration No. 10-1046017.

FIG. 1 is an exploded perspective view of a portable terminal according to the prior art, and FIG. 2 is a plan view showing haptic feeling through a touch of a portable terminal according to the prior art.

Referring to FIGS. 1 and 2, a portable terminal 1 includes a housing 3 and a haptic feedback device 2. The haptic feedback device 2 includes a touch panel 2a, an actuator 2c, and a vibration plate 2b. The portable terminal 1 corresponds to a device requiring vibration, such as a portable terminal provided with a touch panel, a vending machine, an MP3 player, etc. The touch panel 2a corresponds to a part, which is provided at an inside portion of the housing 3 and functions to allow an input of data therethrough or show output data thereon. The actuator 2c is located closely to the touch panel 2a and vibrates in an up-and-down direction in response to a contact signal of the touch panel 2a. The vibration plate 2b is located between the touch panel 2a and the actuator 2c to extend vibration of the actuator 2c to vibration of the entire touch panel 2a. Therefore, in response to a contact signal caused by touching of the touch panel 2a by the user, etc., a vibration feeling of the actuator 2c and the vibration plate 2b is applied to the touch panel 2a and the housing 3. Through the haptic feedback by the vibration, the user can recognize whether to enter or select data displayed in the touch panel 2a.

When the user touches the touch panel 2a, the user operates the portable terminal 1 while gripping a backside portion of the housing 3 using a hand H. Therefore, as shown in FIG. 2, the vibration generated by the actuator 2c vibrates the touch panel 2a and the housing 3, and the user thus can receive the haptic feedback through both the hand H gripping the housing 3 and the other hand H touching the touch panel 2a. As a result, because the haptic feedback device vibrates the entire portable terminal 1, there is a problem in that the vibration feeling is transmitted more heavily to the hand H gripping the portable terminal 1 than to a touching finger F of the remaining hand H. Also, because the user senses a normal vibration feeling rather than an operation feeling through the touch of the portable terminal 1, there occurs a problem in creating a poor UX (User eXperience) related to the touch of the portable terminal 1. Further, there is raised a problem of lowering reliability of the haptic feedback in relation to data selection, whether a data input exists, and accuracy of data through the touch of the portable terminal 1 by the user.

### SUMMARY OF THE INVENTION

Accordingly, an aspect of the present invention is to solve at least the above-described problems occurring in the prior art, and to provide a portable terminal which can enhance the satisfaction of a user by generating vibration only at a touched portion of a touch panel, when the user touches the touch panel.

Another aspect of the present invention is to provide a portable terminal which can individually transfer multiple haptic feedbacks to fingers dragging on the touch panel or fingers touching two or more portions when the user performs dragging on a touch panel, or makes multiple touches on two or more portions of the touch panel.

Therefore, an aspect of the present invention provides a portable terminal, which includes a haptic device; and a plurality of actuators arranged in the haptic device, each of the actuators locally generating vibration in response to a touch on the haptic device.

In an embodiment of the present invention, the actuators are arranged in an n×m array.

The portable terminal may further include vibration-shielding walls disposed between the actuators, wherein the vibration-shielding walls prevent vibration of an operating actuator from being transferred to neighboring actuators adjacent to the operating actuator.

The vibration-shielding walls extend in a vertical direction and are arranged in a (n+1)×(m+1) array, so as to form a plurality of cells surrounding the actuators, respectively, and the cells prevent vibration of an actuator from being transferred to neighboring actuators adjacent to the actuator.

Another aspect of the present invention provides a portable terminal, which includes a touch panel; a plurality of cells formed by partitioning the touch panel; and a plurality of actuators respectively located in the cells and separately operated from each other, wherein the plurality of actuators are locally operated in response to a contact on the touch panel.

In an embodiment of the present invention, the cells are arranged in an n×m array, and the actuators are located in the cells, respectively, to be isolated from each other.

The portable terminal may further include vibration-shielding walls and a terminal body, wherein the vibration-shielding walls are located between the touch panel and the terminal body to isolate the cells from each other and prevent vibration of the plurality of actuators from being transferred from one cell to neighboring cells adjacent to the one cell.

### BRIEF DESCRIPTION OF THE DRAWINGS

The above and other aspects, features, and advantages of the present invention will be more apparent from the following detailed description taken in conjunction with the accompanying drawings, in which:

FIG. 1 is an exploded perspective view of a portable terminal according to the prior art;

FIG. 2 is a plan view virtually showing haptic feeling through a touch of a portable terminal according to the prior art;

FIG. 3 is an exploded perspective view showing a portable terminal including a plurality of actuators according to one embodiment of the present invention;

FIG. 4 is a top plan view showing the portable terminal of FIG. 3 in an assembled state;

FIG. 5 is a cross-sectional view taken along line A-A′ of FIG. 4;

FIG. 6 is a simulated view showing a vibration distribution of a haptic device when one position of a touch panel in the portable terminal of FIG. 4 is touched;

FIGS. 7A to 7E are cross-sectional views showing various installation states of the actuators of FIG. 3, in order to show the arrangement states of the actuators;

FIG. 8 is a photograph showing touch of multiple points of a touch panel by the portable terminal of FIG. 4; and

FIG. 9 is a block diagram simply showing a plurality of actuators of FIG. 4 and a controller of the plurality of actuators.

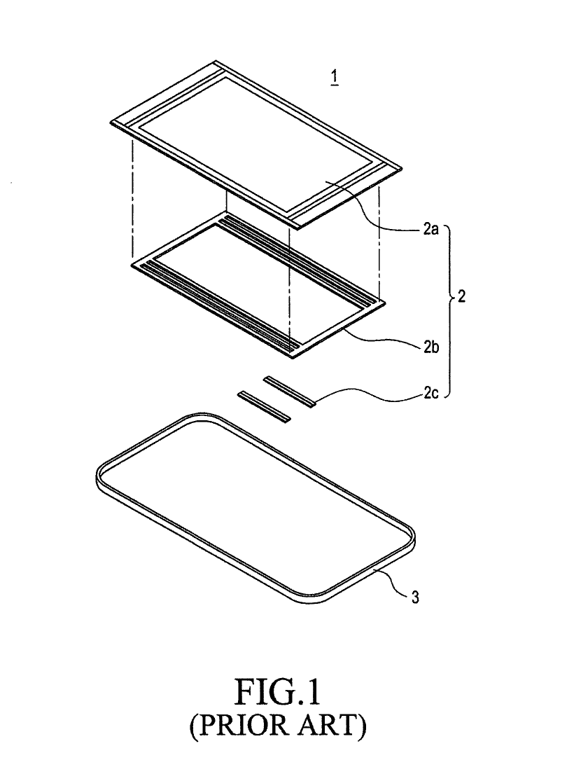

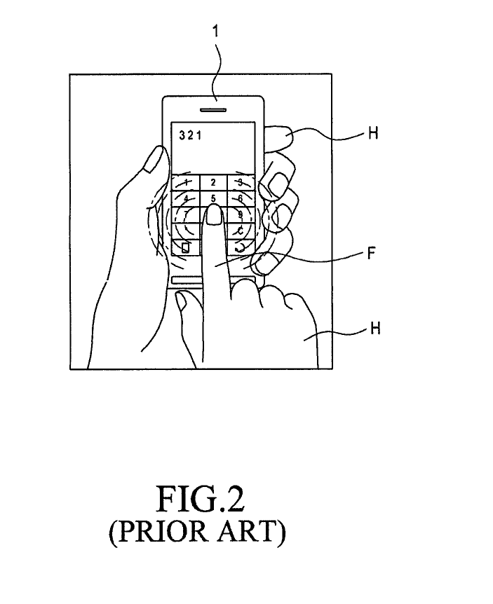

### DETAILED DESCRIPTION OF EMBODIMENTS OF THE PRESENT INVENTION

Hereinafter, various embodiments of the present invention will be described with reference to the accompanying drawings. In the following description, the thickness of lines illustrated in the drawings or the size of the elements may be exaggerated for convenience and clarification of description. Further, various specific definitions found in the following description are provided only to help general understanding of the present invention, and it is apparent to those skilled in the art that the present invention can be implemented without such definitions. Therefore, the definition of those terms should be based on the entire contents of the present specification.

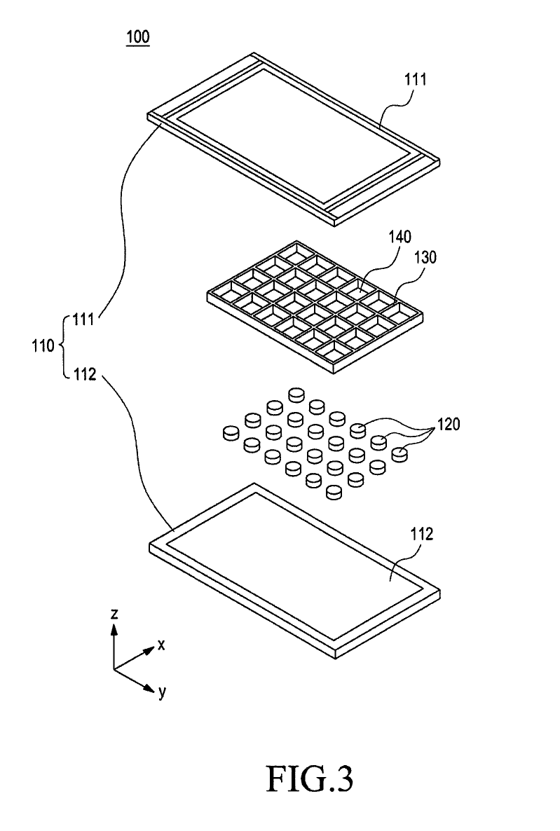

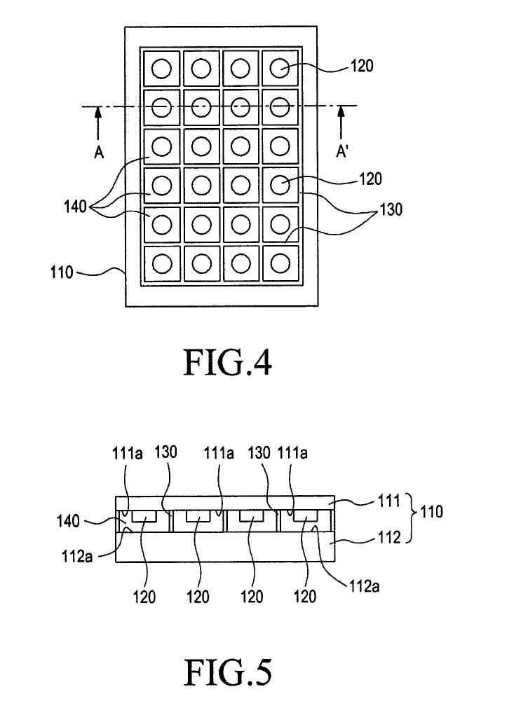

FIG. 3 is an exploded perspective view showing a portable terminal including a plurality of actuators according to one embodiment of the present invention, and FIG. 4 is an assembled top plan view showing a portable terminal shown in FIG. 3. Referring to FIGS. 3 and 4, a portable terminal 100 according to one embodiment of the present invention includes a haptic device 110 requiring vibration, and a plurality of actuators 120 which provide the haptic device 110 with a haptic feeling such as vibration.

The haptic device 110, which requires vibration, therein, refers to a device capable of receiving a haptic feedback according to an operation of the haptic device 110 by the user. In the present embodiment, a terminal having a haptic device is used as a generic name for a terminal requiring vibration, such as the portable terminal 100, a vending machine, or an MP3 player, which is provided with a touch panel 111, and the haptic device 110 refers to a touch panel 111 requiring vibration. The touch panel 111 is disposed on a terminal body 112. Thus, the vibration generated by the actuators 120 not only vibrates the touch panel 111 but is also transmitted to the terminal body 112 provided with the touch panel 111.

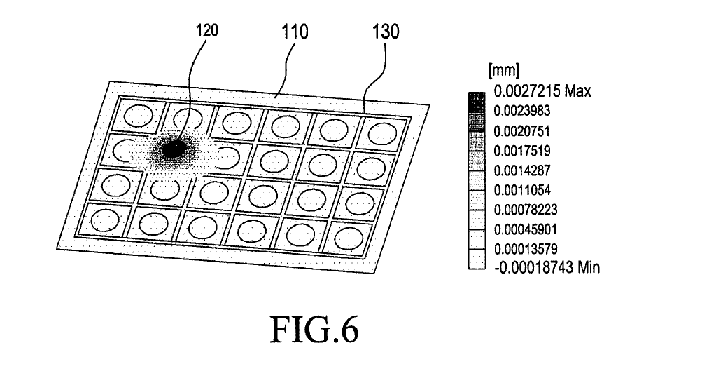

The actuators 120 are arranged in an n×m array in the haptic device 110, and more specifically, between the touch panel 111 and the terminal body 112. Because each of actuators 120 is individually controlled by a controller 160 (see FIG. 9), only an actuator 120 at a touched position of the touch panel 111 can be locally operated. Therefore, the user can receive the haptic feedback, not from all the haptic device 110 but from only the touched position of the touch panel 111. For example, referring to FIG. 6, which will be described later in more detail, when a user touches a point of the touch panel 111 corresponding to a (2×3) position in a structure having a 4×6 array of the actuators 120, only the actuator 120 at the (2×3) position is operated to enable the user to sense a vibration feeling only at the (2×3) position, rather than the other positions.

In the present embodiment, the actuators 120 arranged in a shape of an n×m lattice are described based on examples of a vibration motor, piezo, electro-active polymer, etc. However, the actuators 120 is not limited thereto, and may have various modifications which have a structure capable of providing a local haptic device 110 on each touched position of the touch panel 111.

FIG. 5 is a cross sectional view of the portable terminal, taken along line A-A′ of FIG. 4, and FIG. 6 is a simulated view showing a vibration distribution of a haptic device when one position of a touch panel in the portable terminal of FIG. 4 is touched. Referring to FIGS. 5 and 6, each actuator 120 is surrounded by vibration-shielding walls 130, which spatially isolate the actuator 120 from adjacent actuators 120. In a plan view of the vibration-shielding walls 130, the vibration-shielding walls 130 extend in a transverse direction (an x-axis direction in FIG. 3) and extend in a longitudinal direction (a y-axis direction in FIG. 3) in a shape of a lattice, so as to form cells 140 which surround the actuators 120 in all directions, respectively. The cells 140 are arranged in the same shape as the actuators 120 arranged in the n×m array, so as to have the actuators 120 placed therein. In a cross sectional view of the vibration-shielding walls 130, the vibration-shielding walls 130 are located between a lower surface 111a of the touch panel 111 and an upper surface 112a of the terminal body 112 in a vertical direction (a z-axis direction in FIG. 3). As described above, a plurality of cells 140 are formed by the vibration-shielding walls 130 surrounding the actuators 120, which are located in the cells 140, respectively. The vibration-shielding walls 130 surrounding the actuators 120, which are arranged in the n×m array, are arranged in an (n+1)×(m+1) array in the transverse and longitudinal directions.

Each of the actuators 120 located in the cells 140 is spatially isolated from neighboring actuators 120 thereof by the vibration-shielding walls 130. Thus, when an actuator 120 on a touched position of the touch panel 111 is operated, vibration of the actuator 120 is absorbed by the vibration-shielding walls 130 surrounding the actuator 120, and is thus prevented from being transmitted to neighboring cells 140 adjacent to the actuator 120. That is, when the user touches a particular area of the touch panel 111, an actuator 120 located directly under the touched point is selected to be operated, and the controller 160 causes only the actuator 120 at the touched point to operate by a haptic signal designated according to UX.

The vibration displacement of the actuator 120 is distributed as shown in FIG. 6. That is, largest vibration occurs at the upper side of the actuator 120, and the vibration displacement decreases as the distance from the actuator 120 increases. In a neighboring cell 140 adjacent to the cell 140 including the actuator 120, the decreasing vibration displacement becomes very weak.

It is preferable that the vibration-shielding walls 130 are made from a material which can absorb the vibration. In the present embodiment, the vibration-shielding wall 130 is made from, for example, silicon or rubber including a soft material, poron, etc. However, the material of the vibration-shielding wall 130 is not limited to these materials. In other words, it goes without saying that any material capable of absorbing the vibration of the actuator 120 to allow vibration of only the cell 140 of the touched position of the touch panel 111 in response to the operation of the actuator at the touched point can be employed according to various embodiments of the present invention.

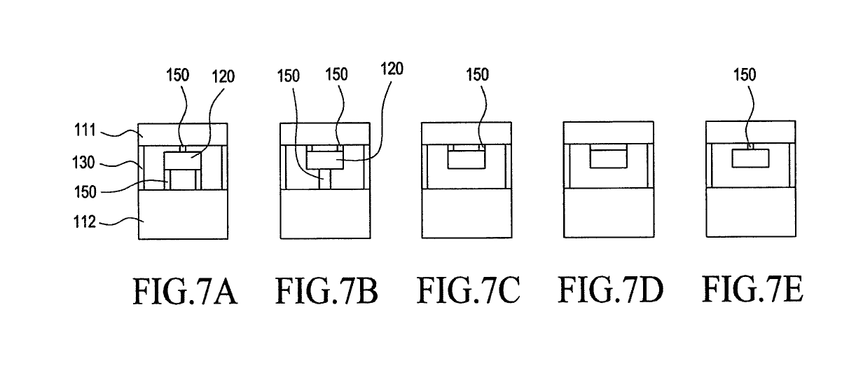

FIGS. 7A to 7D are cross sectional views showing various installation states of the actuators of FIG. 3, in order to show the arrangement states of the actuators. Referring to FIGS. 7A to 7D, a portable terminal according to an embodiment of the present invention further includes a supporter or supporters 150, each of which supports the actuator 120 in the haptic device 110, between the touch panel 111 and the terminal body 112. The supporter 150 supports the actuator 120 while transmitting the vibration of the actuator 120 to the haptic device 110, and to the touch panel 111. An installation location of the supporter 150 can be modified variously. That is, as shown in FIGS. 7A and 7B, the supporter 150 may be provided at both an upper side and a lower side of the actuator 120. In this structure, an upper supporter or upper supporters 150 are fixed to the lower surface 111a of the touch panel 111, and a lower supporter or lower supporters 150 are fixed to the upper surface 112a of the terminal body 112, so that the supporters 150 support the actuator 120 to be located between the touch panel 111 and the terminal body 112. In this structure also, the supporter 150 is configured to transmit the vibration of the actuator 120 to the touch panel 111.

Specifically, as shown in FIG. 7A, one supporter 150 may be located between the lower surface 111a of the touch panel 111 and the upper side of the actuator 120 while two supporters are located between the upper surface 112a of the terminal body 112 and the lower side of the actuator 120. Otherwise, as shown in FIG. 7B, two supporters 150 may be located between the lower surface 111a of the touch panel 111 and the upper side of the actuator 120 while one supporter 150 is located between the upper surface 112a of the terminal body 112 and the lower side of the actuator 120. In this manner, it goes without saying that the number of supporters 150 may be varied without restriction according to various embodiments of the present invention.

Furthermore, as shown in FIGS. 7C to 7E, the actuator 120 may be supported by only a supporter 150 disposed on the lower surface 111a of the touch panel 111.

That is, the supporter 150 may be provided only between the lower surface 111a of the touch panel 111 and the upper side of the actuator 120, so as to transmit the vibration of the actuator 120 to the touch panel 111. In this structure also, it is of course possible to employ limitless modifications in the number or shape of the supporters 150.

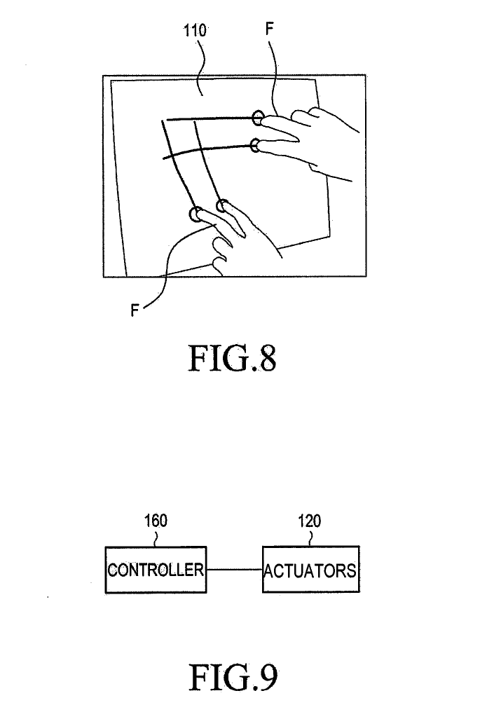

FIG. 8 is a photograph showing touch of multiple points of a touch panel by the portable terminal of FIG. 4, and FIG. 9 is a block diagram simply showing a plurality of actuators of FIG. 4 and a controller of the plurality of actuators. Referring to FIGS. 8 and 9, when the user touches the touch panel 111 using a plurality of fingers F or drags the fingers F on the touch panel 111 in a state in which the fingers F are touching the touch panel 111, the controller 160 causes the actuators 120 corresponding to the touched positions on the touch panel 111 to operate. Thus, the fingers F of the user may receive a haptic feeling differently from each other through the local operation of each of the actuators 120. Also, when the fingers F of the user are dragged on the touch panel 111, the fingers F of the user may receive a haptic feeling differently from each other through the local operation of the actuators 120 at every dragged position on the touch panel 111.

When the user touches a haptic device or a touch panel, a portable terminal having the above construction can locally transfer the haptic feeling to a finger touching the touch panel.

Also, when the user touches the touch panel using a plurality of fingers, not only various haptic signals are generated to create different haptic feelings to be transmitted to the fingers touching the touch panel, but emotional satisfaction of the user can be enhanced.

Further, when the user touches the touch panel using a finger while moving the finger from one position to another position of the touch panel, actuators between the two positions are sequentially vibrated to transfer multiple vibrated haptic feelings to the user.

While the present invention has been shown and described with reference to certain embodiments thereof, it will be understood by those skilled in the art that various changes in form and details may be made therein without departing from the spirit and scope of the present invention as defined by the appended claims.

What is claimed is:

1. A portable terminal comprising:
a haptic device; and
a plurality of actuators arranged in the haptic device, each of the actuators locally generating vibration in response to a touch on the haptic device.

2. The portable terminal of claim 1, wherein the actuators are arranged in an n×m array.

3. The portable terminal of claim 2, further comprising vibration-shielding walls disposed between the actuators, wherein the vibration-shielding walls prevent vibration of an operating actuator from being transferred to neighboring actuators adjacent to the operating actuator.

4. The portable terminal of claim 3, wherein the vibration-shielding walls extend in a vertical direction and are arranged in an (n+1)×(m+1) array, so as to form a plurality of cells surrounding the actuators, respectively, and the cells prevent vibration of an actuator from being transferred to neighboring actuators adjacent to the actuator.

5. The portable terminal of claim 4, wherein the vibration-shielding walls are made from a soft material.

6. The portable terminal of claim 5, wherein the vibration-shielding walls are made from silicon, rubber, or poron.

7. The portable terminal of claim 5, wherein the actuators are supported on an inside bottom surface of the haptic device to transfer the vibration to the haptic device.

8. The portable terminal of claim 5, wherein the actuators are supported by and between a touch panel and a terminal body of the haptic device and transfer vibration to the haptic device.

9. The portable terminal of claims 1, wherein the actuators include a vibration motor, or piezo, or an electro-active polymer.

10. A portable terminal comprising:
a touch panel;
a plurality of cells formed by partitioning the touch panel; and
a plurality of actuators respectively located in the cells and separately operated from each other,
wherein the plurality of actuators are locally operated in response to a contact on the touch panel.

11. The portable terminal of claim 10, wherein the cells are arranged in an n×m array, and the actuators are located in the cells, respectively, to be isolated from each other.

12. The portable terminal of claim 11, further comprising vibration-shielding walls,
wherein the vibration-shielding walls are located between the touch panel and a terminal body of the portable terminal to isolate the cells from each other and prevent vibration of the plurality of actuators from being transferred from one cell to neighboring cells adjacent to the one cell.

13. The portable terminal of claim 12, wherein the vibration-shielding walls are made from a material absorbing vibration of the plurality of actuators.

14. The portable terminal of claim 10, wherein each of the actuators is supported by a supporter between the touch panel and a terminal body of the portable terminal.

15. The portable terminal of claim 10, wherein, when multiple points of the touch panel are touched, actuators corresponding to the multiple points generate a haptic signal independently from each other.
